(19) United States
(12) Patent Application Publication
(10) Pub. No.: US 2026/0309296 A1
(43) Pub. Date: Oct. 8, 2026

(54) LIGHT ASSEMBLY, LIGHTING DEVICE AND VEHICLE

(71) Applicant: Motherson Innovations Company Limited, London (GB)

(72) Inventors: Dave Chamberlain, London (GB); Shuvodeep Das, Stuttgart (DE); Andreas Herrmann, Stuttgart (DE); Tauquir Azhar, Stuttgart (DE)

(21) Appl. No.: 19/634,980

(22) Filed: Mar. 31, 2026

(30) Foreign Application Priority Data
Apr. 2, 2025 (DE) 102025112884.7

(51) Int. Cl. F21S 41/64; F21S 43/00

(52) U.S. Cl. CPC F21S 41/645; F21S 43/601

(57) ABSTRACT

A light assembly for a vehicle may comprise at least one light structure with at least one light source, the at least one light source having an ON mode and an OFF mode. The light assembly may further comprise at least one dimming panel configured to at least partially cover the at least one light structure and a control unit. The at least one dimming panel may be configured to be switched between one of an opaque mode status, a transparent mode status, and a semi-transparent mode status. The control unit may be configured to switch the at least one dimming panel between the statuses based on the ON mode or OFF mode of the at least one light source. The light assembly may further comprise at least one lens and a physical vapor deposition (PVD) coating configured to be applied to the at least one lens.

### CROSS-REFERENCE TO RELATED APPLICATIONS

This application claims the benefit of priority to German Patent Application DE 10 2025 112 884.7, filed on Apr. 2, 2025, which is incorporated herein by reference in its entirety.

### BACKGROUND

The present disclosure relates to a light assembly, a lighting device, and a vehicle.

Vehicles, such as passenger cars, vans, and trucks, often include various interior and exterior vehicular lighting components capable of emitting light for various purposes. Additionally, such aforementioned vehicles include various interior and exterior components having coated finishes thereon to improve aesthetics.

U.S. Pat. No. 10,443,808 B1 describes lighting components to shine through a transparent polymeric lens having a chromium based reflective coating on the outer surface of the lens. The chromium-based reflective coating is permeable to some light that is emitted from a light source. The patent also describes that the lighting components also have a transparent polymeric lens with no chromium-based reflective coating. One of ordinary skill in the art would believe this to be because a lighting component would need to have a very high powered lighting component to emit light through a completely coated lens.

As vehicle manufacturers continue to seek ways to enhance overall vehicle lighting functionality and vehicle design, it is often challenging to aesthetically harmonize and/or merge the appearance of various vehicle lighting components with other surrounding vehicular components mounted to a vehicle. One way in which aesthetics are improved is when a lighting structure is hidden behind a coating which allows for the lighting components to function as required to alert other drivers and see in nighttime driving scenarios. However, for lighting components to be able to emit light through such coatings, a lighting component must shine bright enough to be visible through the coatings. This would require higher power requirements for lighting components to achieve the desired result. The higher power requirements put additional strain on the vehicle and its power supply.

With at least the aforementioned challenges and limitations in mind, there is a continuing unaddressed need for vehicular components, particularly vehicular lighting components, which are capable of emitting sufficient amounts of light to effectively perform their intended purpose yet are capable of having an appearance which aesthetically harmonizes and/or merges with other surrounding vehicular components. Additionally, when a lighting component is not in use, hiding the lighting structure from view creates an aesthetically pleasing result. Being able to achieve this with a non-high powered lighting component would solve this unaddressed long felt need in the industry.

### SUMMARY

In one embodiment, the present disclosure provides a light assembly for a vehicle comprising at least one light structure which may be configured with at least one light source. The at least one light source may be configured to have an ON mode and an OFF mode. The light assembly may further comprise at least one dimming panel which may be configured to at least partially cover the at least one light structure. The at least one dimming panel may have one of an opaque mode status, a transparent mode status, and a semi-transparent mode status. Additionally, the at least one dimming panel may be configured to be switched to one of the opaque mode status, the transparent mode status, and the semi-transparent mode status, by a control unit, based on the ON or OFF mode of the at least one light source.

The benefit of having a light assembly as described above is that the light structure behind the lens may be partially hidden with the use of the dimming panel in the opaque and/or semi-transparent mode status. This may have an aesthetically pleasing appearance, and the light assembly may be able to function as intended without the use of a high powered and/or high power consuming light source when in the transparent mode status.

In another embodiment, the at least one dimming panel may be configured to be switched to the transparent mode status, and the at least one light source may be in the ON mode to provide high luminance.

The ability to provide high luminance while the at least one dimming panel may be in the transparent mode status allows the at least one light source to not have to be configured as high power and/or high power consuming.

In yet another embodiment, the at least one dimming panel may be configured to be switched to the opaque mode status. The at least one light source may be in the OFF mode to hide the at least one light structure.

Being able to hide the at least one light structure when the at least one dimming panel may be in the opaque mode status provides the light assembly with a visually appealing aesthetic.

In a further embodiment, the at least one dimming panel may be configured to be switched to the semi-transparent mode status, and the at least one light source may be in the ON mode to create a dimming effect.

The dimming effect produced when the at least one dimming panel may be in the semi-transparent mode status and the at least one light source may be in the ON mode, can be aesthetically appealing while the at least one light source itself may not need to be dimmed.

In yet a further embodiment, the light assembly may further comprise at least one lens having a front lens surface and a back lens surface. Also, the light assembly may further comprise a physical vapor deposition (PVD) coating which may be configured to be applied to the at least one lens.

The PVD coating applied to the lens may also assist in hiding the at least one light structure when the at least one light source is in either the ON mode or the OFF mode. Additionally, the PVD coating may provide the light assembly with an aesthetically appealing appearance.

In one embodiment, the at least one dimming panel may have a front dimming surface and a back dimming surface. The front lens surface may be exposed to an outside environment while the back lens surface may have the PVD coating. The PVD coating may contact the front dimming surface.

This example may be one way in which the components of the at least one dimming panel and the at least one lens with a PVD coating may be arranged to achieve the light structure being partially hidden.

In another embodiment, the front lens surface may have the PVD coating and is exposed to the outside environment. The back lens surface contacts the front dimming surface.

This example may be another way in which the components of the at least one dimming panel and the at least one lens with a PVD coating may be arranged to achieve the light structure being partially hidden.

In yet another embodiment, the front dimming surface may be exposed to the outside environment. The front lens surface may have the PVD coating and contact the back dimming surface.

This example may be yet another way in which the components of the at least one dimming panel and the at least one lens with a PVD coating may be arranged to achieve the light structure being partially hidden.

In a further embodiment, the at least one dimming panel may be configured from any one of: a liquid crystal display (LCD) glass, a polymer dispersed liquid crystal (PDLC) glass, a suspended particle device (SPD) glass, a thermochromic glass, a photochromic glass, a micro-blind glass, or other electrochromic glass.

The benefit of using one of these types of electrochromic glass may be their ability to switch from the opaque mode status to the transparent mode status quickly. Enabling the at least one light source and the light structure to be seen or hidden rapidly.

In one embodiment, the light assembly may further comprise at least one mask applied to the at least one lens and/or the at least one dimming panel to at least partially hide the at least one light structure.

The combination of the at least one mask and the at least one dimming panel may completely hide the light structure when the dimming panel is in the opaque and/or semi-transparent mode status and the at least one light source is in the OFF mode.

In one preferred embodiment, the control unit is configured to control the switching of the dimming panel smoothly. Smoothly switching means that the dimming panel is changing its status from an opaque mode status, transparent mode status or semi-transparent mode status and back not abruptly or suddenly, but in a smooth or steady manner within a predetermined time period. This has the advantage that the switching of the dimming panel does not appear to be flash-like, which is generally regarded as more appealing and pleasant for an external viewer. In particular, the predetermined time period is within 1 sec and preferably within 0.5 sec, however, it may also be possible to have a larger or smaller duration for time period for the completion of the switching process. In yet another embodiment, the present disclosure describes a lighting device comprising at least one light assembly according to any in the present disclosure.

In yet a further embodiment, the present disclosure describes the vehicle comprising at least one light assembly and/or lighting device according to any in the present disclosure.

In the aforementioned embodiments there are advantages over the prior art of the light assembly, such as having a light assembly with at least one light source that does not need to be high powered and/or require high power consumption while the at least one lighting structure can be at least partially hidden when the at least one light source is in the OFF mode by utilizing at least one dimming panel. The at least one dimming panel being able to function in one of the opaque mode status or semi-transparent mode status allows for at least one light structure to be hidden to create an aesthetically appealing look of the vehicle.

### BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the disclosure is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the disclosure. The figures are not necessarily drawn to scale. Like numbers used in the figures refer to like components. However, it will be understood that the use of a number to refer to a component in a given figure is not intended to limit the component in another figure labelled with the same number.

Other aspects, advantages, and salient features of the present disclosure will become apparent to those skilled in the art from the following detailed description disclosing one or more embodiments of the present disclosure by way of example only, which taken in conjunction with the annexed drawings, discloses exemplary embodiments of the disclosure, wherein:

FIG. 1 illustrates a perspective view of a rear of a vehicle;

FIG. 2 illustrates a cross sectional view of a light assembly according to an embodiment;

FIG. 3 illustrates a cross sectional view of the light assembly according to another embodiment;

FIG. 4 illustrates a cross sectional view of the light assembly according to yet an embodiment; and

FIG. 5 shows a block diagram for illustrating a further schematic embodiment of a light assembly for a vehicle.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also, the use of relational terms, such as but not limited to, “top,” “bottom,” “left,” “right,” “upper,” “lower,” “down,” “up,” “side,” are used in the description for clarity and are not intended to limit the scope of the disclosure or the appended claims. Further, it should be understood that any one of the features can be used separately or in combination with other features. Other systems, methods, features, and advantages of the disclosure will be or become apparent to one with skill in the art upon examination of the detailed description. It is intended that all such additional systems, methods, features, and advantages be included within this description, be within the scope of the present disclosure, and be protected by the accompanying claims.

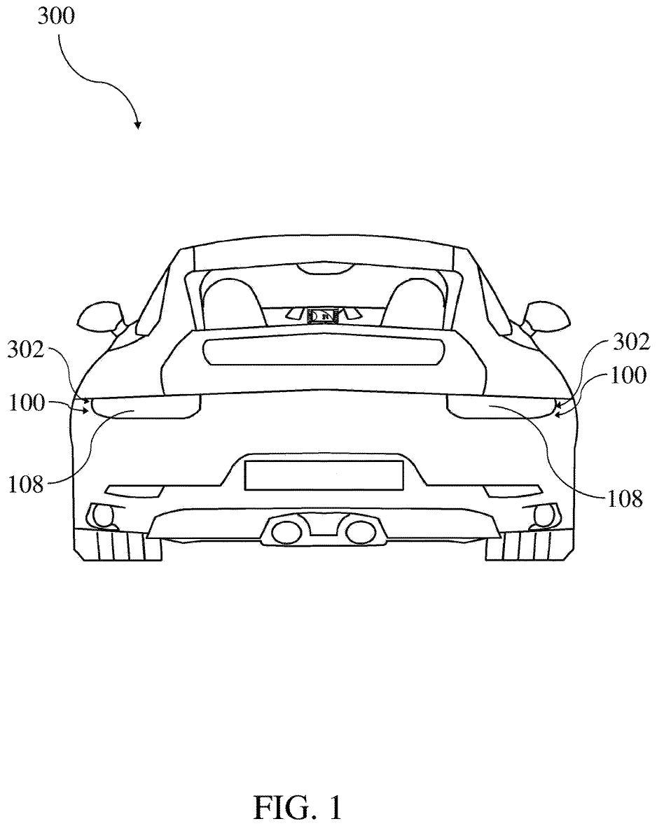

FIG. 1 illustrates a perspective view of a rear of a vehicle 300 comprising at least one light assembly 100. Additionally, the vehicle 300 may comprise a lighting device 302 which may also comprise at least one light assembly 100 but may also comprise more than one light assembly 100. In FIG. 1, the at least one light assembly 100 is shown on the rear of the vehicle 300. The at least one light assembly 100 may be used as brake lights, running taillights, and/or turn signal indicators. However, other locations and uses on the vehicle 300 as known by a person of ordinary skill in the art, such as head lights, both high beam and low beam lights, front turn signal indicators, side turn signal indicators, including side turn signal indicators found on a rear view device. In an embodiment of the at least one light assembly 100 shown in FIG. 1, there may be at least one lens 108 exposed to an outside or an external environment.

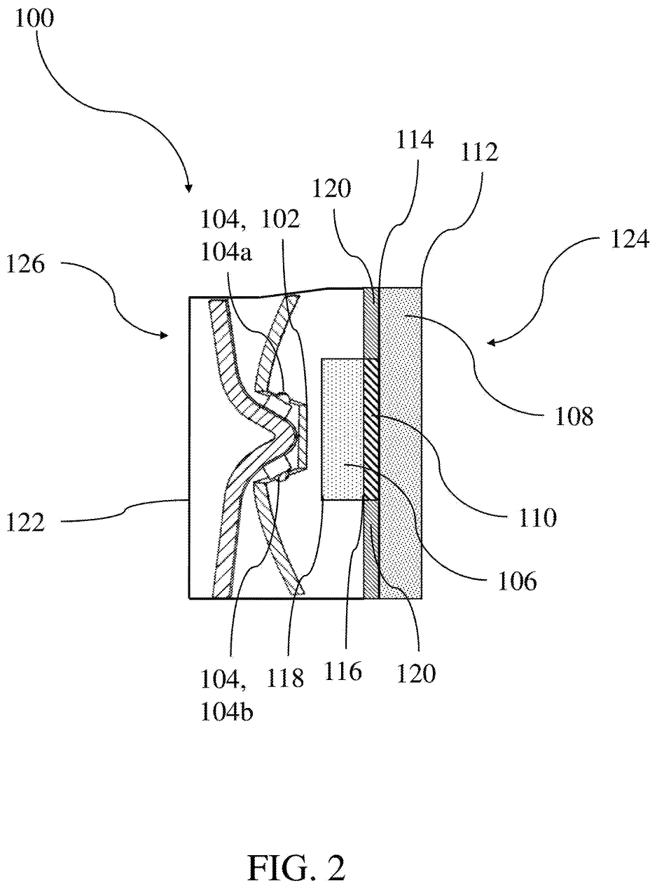

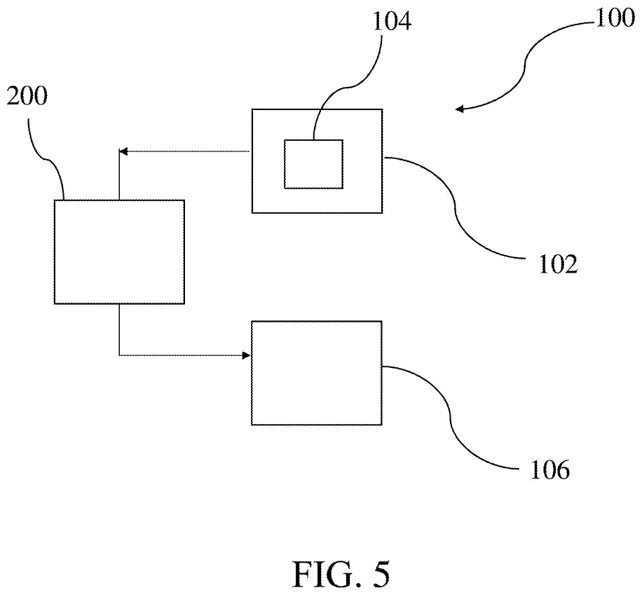

FIG. 2 illustrates a cross sectional view of a light assembly 100 for the vehicle 300 according to an embodiment. The light assembly 100 may comprise at least one light structure 102 configured with at least one light source 104 and the at least one light source 104 may be configured to have an ON mode and an OFF mode. The light assembly 100 may further comprise at least one dimming panel 106 configured to at least partially cover the at least one light structure 102 and the at least one dimming panel 106 having one of an opaque mode status, a transparent mode status, and a semi-transparent mode status. Wherein the at least one dimming panel 106 may be configured to be switched between one of the opaque mode status, the transparent mode status, or the semi-transparent mode status, by a control unit 200 (see FIG. 5), based on the ON or OFF mode of the at least one light source 104.

In one state, the light assembly 100 may have the at least one dimming panel 106 being configured to be switched to the transparent mode status when the at least one light source 104 is in the ON mode to provide high luminance. Or said another way, when a brake pedal of the vehicle 300 is activated, the control unit 200 senses this and switches the at least one light source 104 to the ON mode, which illuminates the at least one light source 104 and at the same time, or very close to the same time. The at least one dimming panel 106 switches to the transparent mode status allowing for the at least one light source 104 to be seen. The at least one light source 104 may provide high luminance while using a normal amount of power. A high powered and/or high power consuming light source 102 is not needed in this disclosure.

In another state, the light assembly 100 may have the at least one dimming panel 106 being configured to be switched to the opaque mode status, and the at least one light source 104 may be in the OFF mode to at least partially hide that at least one light structure 102. The at least one light structure 102 may comprise the at least one light source 104, reflectors, supporting structures, and other components commonly found behind a lens of a headlight, taillight, and/or other lighting features found in vehicles 300. There may be an aesthetically appealing look to at least one light assembly when the opaque mode status of the at least one dimming panel 106 and the OFF mode of the at least one light source 104.

In yet another state, the light assembly 100 may have the at least one dimming panel 106 configured to be switched to the semi-transparent mode status, and the at least one light source 104 in the ON mode to create a dimming effect. The semi-transparent mode status of the at least one dimming panel 106 allows for some light from the at least one light source 104 to pass through but not all. The amount of light allowed to pass, or a transmissive property, through may be variable and adjustable between 20% and 80% to create the desired dimming effect. The dimming effect may be aesthetically appealing.

As shown in FIGS. 2-4, the light assembly 100 may further comprise the at least one lens 108 having a front lens surface 112 and a back lens surface 114, and a physical vapor deposition (PVD) coating 110 configured to be applied to the at least one lens 108. The PVD coating 110 of the at least one lens 108 may create a shading or tinting of the at least one lens 108 which may assist in at least partially hiding the at least one lighting structure 102. The PVD coating 110 may be applied to the front lens surface 112 and/or the back lens surface 114 depending on the desired effect. The PVD coating 110 may also be a chrome or reflective coating.

Also shown in FIGS. 2-4 is the at least one dimming panel 106, which may comprise a front dimming surface 116 and a back dimming 118 surface. The front and back dimming surfaces 116, 118 are used to show the orientation of different embodiments of the present disclosure. Additionally, the dimming panel 106 may have the PVD coating 110 on the front dimming surface 116 and/or the back dimming surface 118. Furthermore, the at least one dimming panel 106 may be configured from any one of: a liquid crystal display (LCD) glass, a polymer dispersed liquid crystal (PDLC) glass, a suspended particle device (SPD) glass, a thermochromic glass, a photochromic glass, a micro-blind glass, or other electrochromic glass. A specific electrochromic glass may be able to switch between the opaque mode status and the transparent mode status very quickly. This feature may be necessary for safety and to allow the at least one light source 104 be visible the moment a driver steps on a brake pedal.

As shown in FIGS. 2-4, the light assembly 100 may further comprise at least one mask 120 applied to the at least one lens 108 and/or the at least one dimming panel 106 to at least partially hide the at least one light structure 102. The combination of the at least one mask 120, the at least one dimming panel 106 in the opaque mode status, and the PVD coating 110 together may give the appearance of a surface of the vehicle 300 and not a light. This feature may be known as a hidden until lit system. The feature may be aesthetically appealing while also meeting or exceeding all safety standards while not requiring the use of the high powered and/or high energy consumption at least one light source 102.

FIG. 2 illustrates a cross sectional view of a light assembly 100 according to an embodiment. As shown in FIG. 2, the light assembly 100 may comprise a housing 122, and the housing 122 may comprise a front housing portion 124 and a rear housing portion 126. The front housing portion 124 may face an exterior of the vehicle 300 while the rear housing portion 126 may be fastened to the vehicle 300. As shown in FIG. 2, the front housing portion 124 may comprise, the front lens surface 112 being exposed to an outside environment and the back lens surface 114 has the PVD coating 110 and the PVD coating 110 contacts the front dimming surface 116. The rear dimming surface 118 may be near or adjacent to the at least one light structure 102 and the at least one light source 104, 104a, 104b. Also shown in FIG. 2, the at least one light source 104 may comprise a first light source 104a and a second light source 104b. Additionally, there may be more light sources (not shown) in the light assembly 100. The light structure 102 may be inside of the housing 122 but may also reside outside of the housing 122.

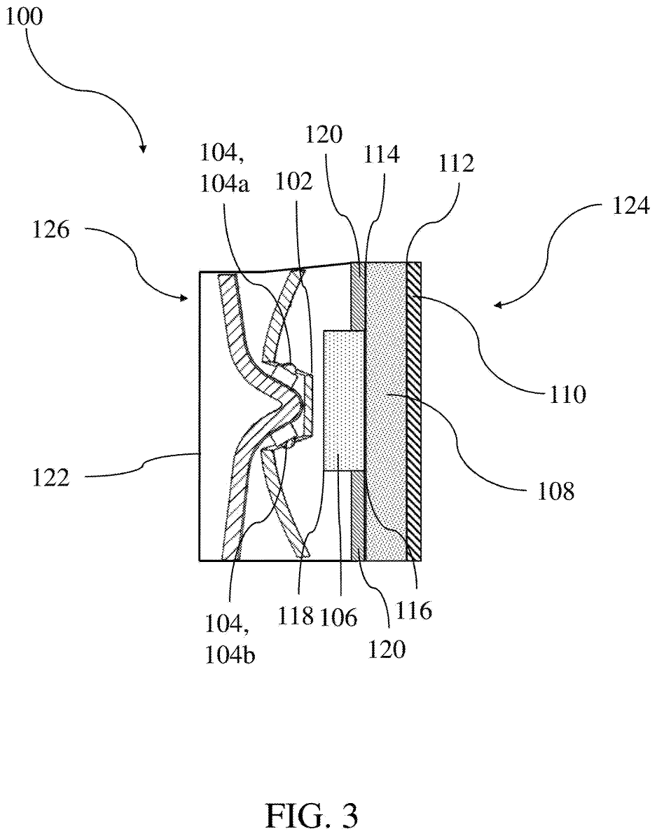

FIG. 3 illustrates a cross sectional view of the light assembly 100 according to another embodiment. As shown in FIG. 3, the light assembly may comprise the housing 122, and the housing 122 may have the front housing portion 124 and the rear housing portion 126. As shown in FIG. 3, the front housing portion 124 may comprise the front lens surface 112 having the PVD coating 110 and may be exposed to the outside environment and the back lens surface 114 contacts the front dimming surface 116.

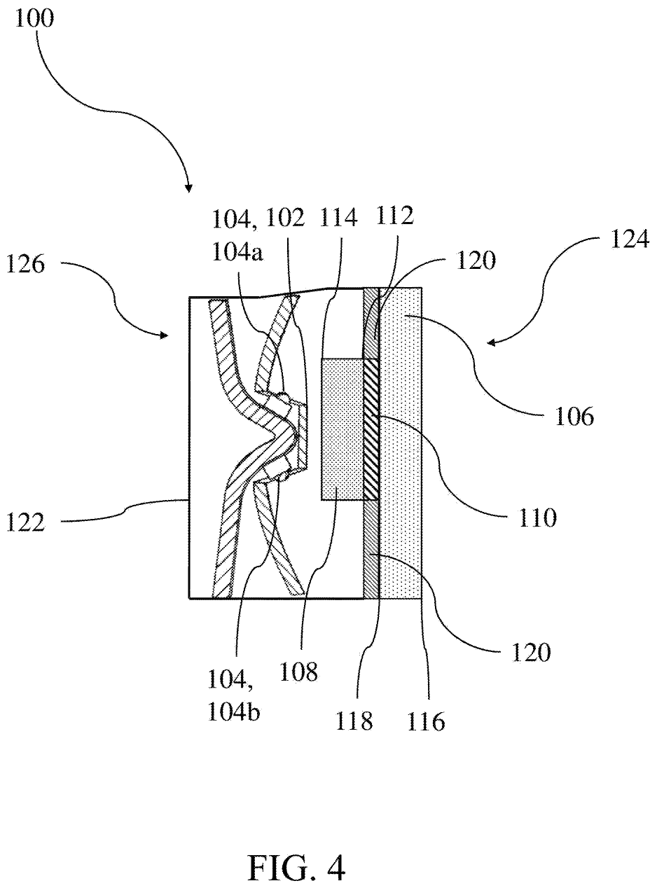

FIG. 4 illustrates a cross sectional view of the light assembly 100 according to yet another embodiment. As shown in FIG. 4, the front housing portion 124 may comprise the front dimming surface 116 being exposed to the outside environment. The front lens surface 112 may have the PVD coating 110 and may contact the back dimming surface 118.

FIG. 5 shows a block diagram for illustrating a further schematic embodiment of a light assembly 100 for a vehicle 300 according to the present invention. The light assembly 100 comprises a light structure 102 with a light source 104 and the dimming panel 106. The light structure 102 and the dimming panel 106 may be of the type as shown and described with regard to the previous FIGS. 2-4. In FIG. 5, the control unit 200 is on the one hand side coupled to the light structure 102 in order to obtain information on whether the light source 104 is currently in the ON mode or OFF mode. The control unit 200 is further coupled to the controllable dimming panel 106. Based on the ON/OFF information that the control unit 200 has obtained from the light structure 102, or its light source 104, the control unit 200 controls operation of the dimming panel 106 to switch the dimming panel 106 to one of the respective mode statuses, such as the opaque mode status, the transparent mode status, or the semi-transparent mode status.

In a particular preferred aspect of the invention, the control unit 200 controls the dimming panel 106 such that the switching into the opaque, transparent, and/or semi-transparent mode status is done in a smooth manner, which means not abruptly.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

Furthermore, the features of the disclosure disclosed in this specification, the claims, and the drawings may be employed both individually and in any possible combination for practicing the disclosure in its various exemplary embodiments. In particular, all claim feature combinations, irrespective of the claim dependencies, are covered with this application.

### REFERENCE SIGNS LIST

100 light assembly
102 light structure
104 at least one light source
104a first light source
104b second light source
106 dimming panel
108 a lens
110 a physical vapor deposition (PVD) coating
112 front lens surface
114 back lens surface
116 front dimming surface
118 back dimming surface
120 mask
122 housing
124 front housing portion
126 rear housing portion
200 control unit
300 vehicle
302 lighting device

What is claimed is:

1. A light assembly for a vehicle, the light assembly comprising:
at least one light structure comprising at least one light source, wherein the at least one light source is configured to have an ON mode and an OFF mode;
at least one controllable dimming panel configured to at least partially cover the at least one light structure, wherein the at least one dimming panel has an opaque mode status, a transparent mode status, or a semi-transparent mode status;
a control unit coupled with the at least one light source and the controllable dimming panel and configured to switch the at least one dimming panel to the opaque mode status, the transparent mode status, or the semi-transparent mode status based on the ON mode or OFF mode of the at least one light source;
at least one lens having a front lens surface and a back lens surface; and
a physical vapor deposition (PVD) coating applied to the at least one lens.

2. The light assembly according to claim 1, wherein the control unit is configured to switch the at least one dimming panel to the transparent mode status when the at least one light source is in the ON mode to provide high luminance.

3. The light assembly according to claim 1, wherein the control unit is configured to switch the at least one dimming panel to the opaque mode status when the at least one light source is in the OFF mode to at least partially hide the at least one light structure.

4. The light assembly according to claim 1, wherein the control unit is configured to switch the at least one dimming panel to the semi-transparent mode status when the at least one light source is in the ON mode to create a dimming effect.

5. The light assembly according to claim 1, wherein the at least one dimming panel has a front dimming surface and a back dimming surface.

6. The light assembly according to claim 5, wherein:
the front lens surface is exposed to an outside environment;
the back lens surface has the PVD coating applied; and
the PVD coating contacts the front dimming surface.

7. The light assembly according to claim 5, wherein:
the front lens surface has the PVD coating and is exposed to the outside environment; and
the back lens surface contacts the front dimming surface.

8. The light assembly according to claim 5, wherein:
the front dimming surface is exposed to the outside environment; and
the front lens surface has the PVD coating and contacts the back dimming surface.

9. The light assembly according to claim 1, wherein the at least one dimming panel is a liquid crystal display (LCD) glass, a polymer dispersed liquid crystal (PDLC) glass, a suspended particle device (SPD) glass, a thermochromic glass, a photochromic glass, a micro-blind glass, or other electrochromic glass.

10. The light assembly according to claim 1, wherein the control unit is configured to control the switching of the dimming panel in a smooth manner such that the dimming panel switches to one of the opaque mode status, the transparent mode status, and the semi-transparent mode status and back within a predetermined time period, in particular within 1 second and preferably within 0.5 seconds.

11. The light assembly according to claim 1, wherein the light assembly further comprises at least one mask applied to the at least one lens or the at least one dimming panel to at least partially hide the at least one light structure.

12. A lighting device comprising at least one light assembly according to claim 1.

13. A vehicle comprising at least one light assembly according to claim 1 or a lighting device according to claim 12.

14. A light assembly for a vehicle, the light assembly comprising:
at least one light structure comprising at least one light source, wherein the at least one light source is configured to have an ON mode and an OFF mode;
at least one controllable dimming panel configured to at least partially cover the at least one light structure, wherein the at least one dimming panel has an opaque mode status, a transparent mode status, or a semi-transparent mode status; and
a control unit coupled with the at least one light source and the controllable dimming panel and configured to switch the at least one dimming panel to the opaque mode status, the transparent mode status, or the semi-transparent mode status based on the ON mode or OFF mode of the at least one light source;
wherein the control unit is configured to switch the at least one dimming panel to the transparent mode status when the at least one light source is in the ON mode, and
wherein the control unit is configured to switch the at least one dimming panel to the opaque mode status when the at least one light source is in the OFF mode.
